(19) United States
(12) Patent Application Publication
(10) Pub. No.: US 2007/0002939 A1
(43) Pub. Date: Jan. 4, 2007

(54) Method and apparatus for testing a data path

(75) Inventor: Charles H. Daugherty, Naperville, IL (US)

Correspondence Address: DAVIS & ASSOCIATES, P.O. BOX 1093, DRIPPING SPRINGS, TX, 78620, US

(73) Assignee: Tellabs Operations, Inc.

(21) Appl. No.: 11/169,865

(22) Filed: Jun. 29, 2005

(51) Int. Cl. H04L 5/16

(52) U.S. Cl. 375/219

(57) ABSTRACT

An apparatus includes a transmitter providing a training pattern on a selected one of n+1 data paths while communicating data on the remaining n of the n+1 data paths. A receiver having adjustment circuitry receives the n+1 data paths and provides n+1 adjusted data paths. The receiver selects a subset of the n+1 adjusted data paths carrying the communicated data while adjusting the selected data path. One method includes sequentially selecting a selected data path from a plurality of data paths coupling a transmitter and a receiver. A training pattern is communicated on the selected data path to the receiver. The selected data path is adjusted in response to the received training pattern.

### TECHNICAL FIELD

The present invention relates to communications systems. In particular, the present invention is drawn to methods and apparatus for testing and calibrating individual data paths of a multi-path communication system.

### BACKGROUND

As the bit-rate of communication systems increases, the sensitivity of such systems to noise, skew, and jitter increases. Increasing data rates result in shrinking margins for setup and hold times which reduces the available timing budget for factors such as noise, skew, and jitter.

One approach for minimizing the effects of these factors is to match the lengths of clock and data paths. This approach, however, becomes less practical as the pin count of components in the data path increases. The layout matching approach is also labor intensive during board layout and design. This approach does not accommodate small errors in either the design or implementation of the design. Even if the design is correct and implemented correctly, the static nature of this solution does not accommodate changes in behavior that may occur with age, process, voltage, and temperature variations.

One alternative is to provide adjustment circuitry that provides for performing adjustments to the data paths. Prior to the transmission of data, a known training pattern is transmitted by the transmitter on the data path during a calibration or training mode. The received pattern is examined by the receiver to determine the appropriate adjustment to the signals received on each data path. Once the adjustment circuitry is programmed in accordance with the determined adjustment, the data paths may be used for the transmission of data. A disadvantage with this approach is that the data flow between the transmitter and receiver must be interrupted whenever invocation of the calibration or training mode is required.

An alternative approach incorporates a dynamic adjustment circuit for adjusting source synchronous data to a transmitted clock. After an initial calibration, the dynamic adjustment circuit continuously monitors phase adjustment, for example, and performs an adjustment for each data path. A true dynamic adjustment circuit does not require the use of training patterns or training pattern generators and therefore avoids the interruption of data flow. A dynamic adjustment circuit, however, tends to add considerable complexity to the integrated circuit design.

Another alternative approach incorporates a clock data recovery circuit for recovering a sampling clock for the synchronous data. A clock data recovery circuit tends to add considerable complexity to the integrated circuit design.

### SUMMARY

A communication apparatus includes a transmitter providing a training pattern on a selected one of n+1 data paths while communicating data on the remaining n of the n+1 data paths. A receiver having adjuster circuitry receives the n+1 data paths and provides n+1 adjusted data paths. The receiver selects a subset of the n+1 adjusted data paths carrying the communicated data while adjusting the selected data path.

A method includes sequentially selecting a selected data path from a plurality of data paths coupling a transmitter and a receiver. A training pattern is communicated on the selected data path to the receiver. The selected data path is adjusted in response to the received training pattern.

### BRIEF DESCRIPTION OF THE DRAWINGS

FIG. 1 illustrates a prior art communication system utilizing a training pattern for calibration.

FIG. 2 illustrates an improved communication system utilizing a training pattern for adjustment.

FIG. 3 illustrates one embodiment of a method for performing adjustments for individual data paths of a multi-path communication system using training patterns.

FIG. 4 illustrates one embodiment of a calibration process performed by data path adjustment circuitry.

FIG. 5 illustrates one embodiment of a calibration process performed by transmitter circuitry.

FIG. 6 illustrates one embodiment of a calibration process performed by data analyzer circuitry.

FIG. 7 illustrates one embodiment of sequentially selecting a data path for communicating the training pattern as well as the assignment of data streams to the remaining data paths.

### DETAILED DESCRIPTION

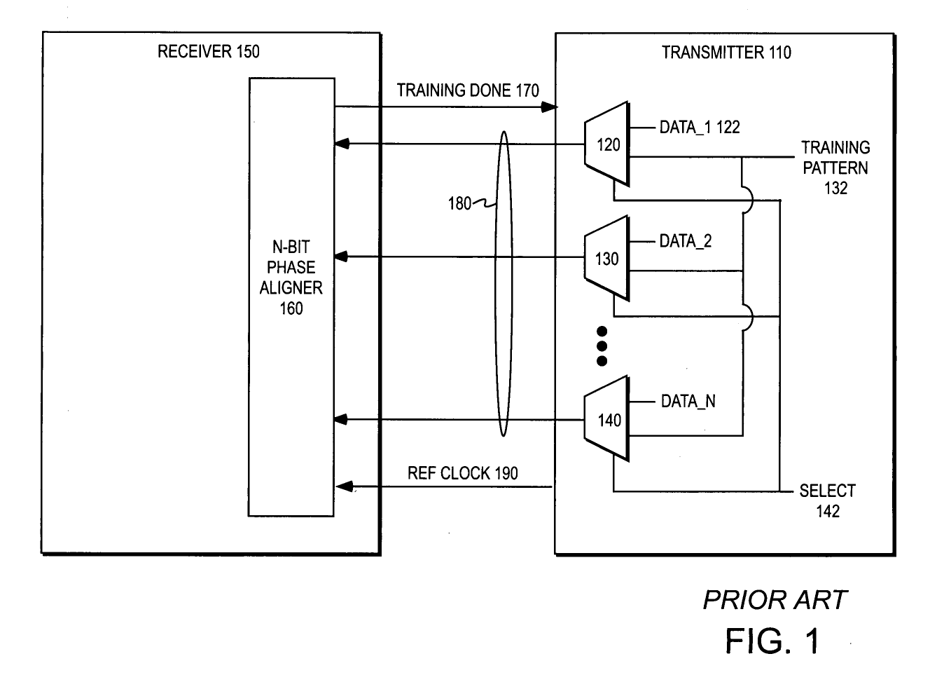

FIG. 1 illustrates one embodiment of a prior art communication system utilizing phase adjustment circuitry in conjunction with a training pattern. The transmitter 110 and receiver 150 are coupled by data paths 180. The receiver also receives reference clock 190.

Each data path is coupled to a multiplexer 120, 130, 140 for selecting between the training pattern 132 or a data stream (e.g., DATA_1 122) associated with that path in accordance with a select signal 142. Thus select 142 determines whether the data paths 180 are carrying their respective data streams (e.g., DATA_1 122), or a training pattern 132.

The n data paths 180 collectively form a parallel communication path. Each data path represents a different bit position of the byte, word, etc. being communicated.

When in the calibration mode, an n-bit phase adjuster 160 analyzes the training patterns received on each data path along with the source synchronous clock 190 in order to determine and make the appropriate phase adjustment to each path. Once the phase adjustment is completed, the phase adjuster sends a “training done” signal 170 back to the transmitter 110. Upon receipt of the training done signal, the transmitter may resume sending the data (e.g., DATA_1 122) rather than the training pattern on the data paths 180.

When using the calibration mode, none of the data paths 180 is available for transmitting data. The unavailability of even one data path during calibration renders parallel data communications unavailable. Depending upon the transmitter's buffering capability and the receiver's ability to process buffered data, the interruption of data flow during calibration can result in the loss of data. At the very least, interruption of data flow results in a reduced communication bandwidth.

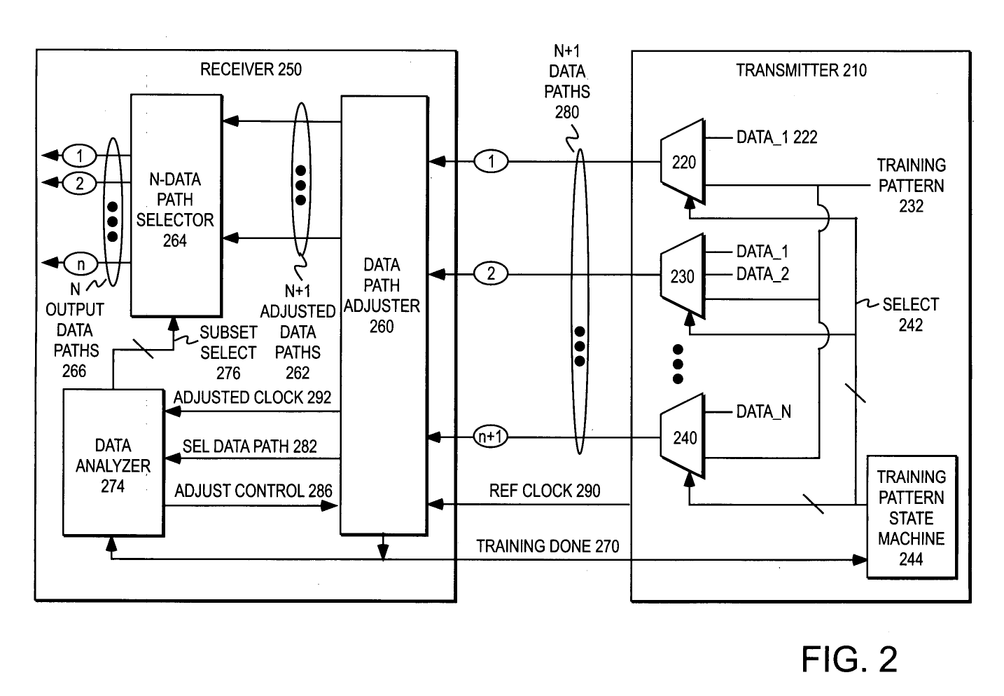

FIG. 2 illustrates an improved communication system utilizing a training pattern for data path adjustment. The data paths 280 may be analog or digital in nature. Each digital data path may be one or more bits wide. Each data path may represent single or multiple channels of communication. For example, a data path may be a time-division multiplexed data path supporting a plurality of channels.

The data paths 280 may form a plurality of serial communication data paths wherein there is no pre-determined relationship between the data carried by one data path and the data carried by another data path. Alternatively, the data paths 280 may collectively form one or more parallel communication paths wherein data carried by an individual data path forms part of a logical grouping (e.g., nibble, byte, word, doubleword, etc.) with data carried by one or more other data paths. In various embodiments, the data paths 280 may be implemented wirelessly or through electrically or optically conductive media such as wires, cables, or optical fibers.

The communication system of FIG. 2 is provided with a “spare” data path and appropriate selection circuitry to permit calibrating one data path while data is being communicated on the remaining data paths. Thus, for example, a calibration operation may be performed on one of n+1 data paths 280 while the remaining n data paths continue to communicate data.

In the illustrated embodiment, the transmitter 210 includes a plurality of multiplexers 220-240, one associated with each of the n+1 data paths 280 that are communicatively coupled to the receiver 250. In one embodiment, the transmitter also provides a reference clock 290 to the receiver.

Each multiplexer 220-240 may select from the training pattern 232 or one or more data streams such as DATA_1 222 in accordance with a select 242 provided by a training pattern state machine 244. Each multiplexer 220-240 may be uniquely controlled to select one of its inputs in accordance with select 242. In one embodiment, select 242 is a plurality of individual signal lines wherein each multiplexer 220-240 is controlled by a unique subset of those signal lines. The training pattern state machine 244 establishes the assignment of n data streams to the n+1 data paths 280 for transmission to the receiver 250. The training pattern state machine also establishes the sequence in which individual data paths of the n+1 data paths 280 are selected for calibration.

The n+1 data paths 280 are provided to the data path adjuster 260 of receiver 250. In one embodiment, the reference clock 290 is also provided to the data path adjuster. Data path adjuster 260 provides the appropriate adjustment for each of the incoming data paths 280 in response to the training pattern. Data path adjuster 260 outputs a plurality of n+1 adjusted data paths 262 to an n-data path selector 264 which selects the subset of the n+1 adjusted data paths 262 that are not being calibrated in accordance with the subset select 276 provided by the data analyzer 274. The selected subset is provided by the n-data path selector 264 as output paths 266.

Although data path adjuster 260 may be used to correct phase alignment, different applications may require different or additional types of signal conditioning. For example, data path adjuster 260 may be required to adjust phase, gain, d.c. offset, or some other signal property.

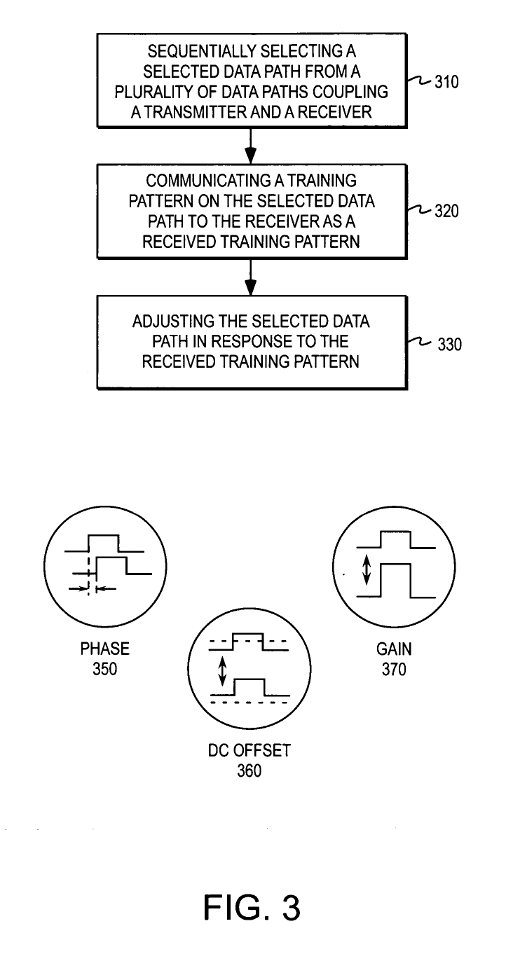

FIG. 3 illustrates one embodiment of a method of testing the data paths. In step 310, a selected data path is sequentially selected from a plurality of data paths coupling a transmitter and a receiver. A training pattern is communicated on the selected data path to the receiver as a received training pattern in step 320. Data may continue to be communicated on the remaining data paths. As long as there are sufficient spare data paths, neither parallel nor serial communications are inhibited when the training pattern is communicated. Thus for example, an n-bit byte or word may be communicated on n of the n+1 data paths while the training pattern is being communicated on one of the n+1 data paths. An adjustment is performed on the selected data path in response to the received training pattern in step 330. The adjustment may be any type of signal conditioning including phase 350, d.c. offset 360, or gain 370. The process of FIG. 3 is repeated with the next selected data path in the selection sequence. In one embodiment, the rate of the repetition of the steps of FIG. 3 may be increased when compensating for fast dynamic effects or decreased when compensating for slow dynamic effects.

Termination of the calibration of each data path may be handled in various ways. In one embodiment, the training pattern may have a pre-determined length such that the receiver and transmitter synchronously switch selected data paths upon conclusion of the training pattern. In another embodiment (with reference to FIG. 2), the receiver is capable of communicating a training done signal 270 to the transmitter. Some co-ordination is required between the transmitter 210 and receiver 250 to ensure that the receiver's n-data path selector 264 selects the appropriate subset of the n+1 adjusted data paths 262 as output paths 266 at substantially the same time that the transmitter changes the assignment of data streams in order to avoid the loss of data.

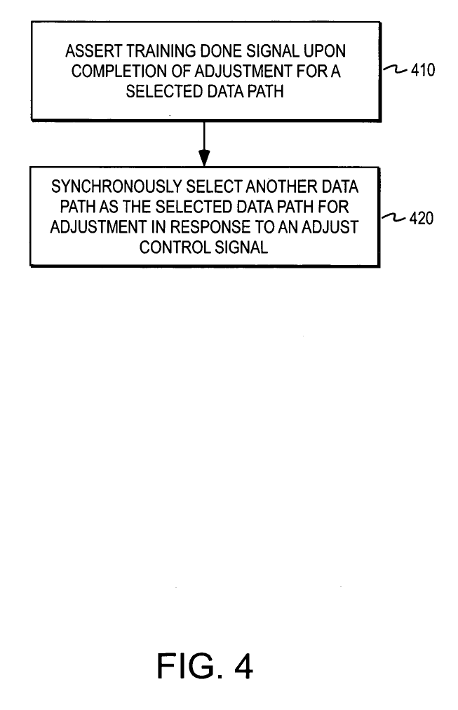

FIG. 4 illustrates one embodiment of a calibration process performed by the data path adjuster 260 of FIG. 2. In step 410, the data path adjuster asserts a training done signal upon completion of the adjustment for a selected data path. In step 420, the data path adjuster synchronously selects another data path as the selected data path for adjustment in response to an adjust control signal. The adjust control signal is only asserted upon acknowledgement that the transmitter has received the training done signal. After changing to a different selected data path, the training done signal is de-asserted until training is completed again.

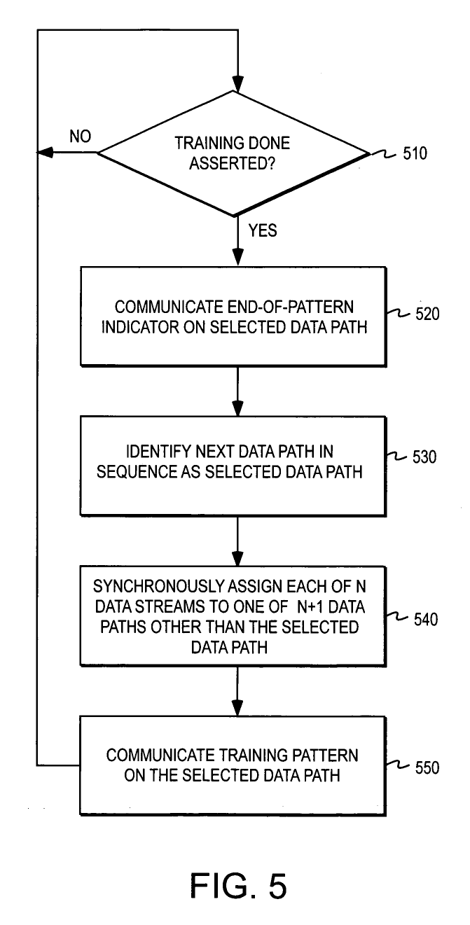

FIG. 5 illustrates one embodiment of the calibration process performed by the transmitter 210 of FIG. 2. In step 510, the training pattern state machine determines whether the training done signal has been asserted. Once the training done signal has been asserted, the training pattern state machine communicates an end-of-pattern indicator on the selected data path in step 520. The end-of-pattern indicator may be a pre-determined digital code, for example. This end-of-pattern indicator serves as an acknowledgement that the transmitter has received the training done signal and is preparing to select another data path as the selected data path for calibration.

The training pattern state machine identifies the next data path in the calibration sequence as the selected data path in step 530. In step 540, the training pattern state machine synchronously assigns each of the n data streams to one of the n+1 data paths other than the selected data path. Referring to FIG. 2, this assignment is handled by select 242 and multiplexers 220-240. The assignment occurs on the clock cycle immediately after the end-of-pattern indicator is transmitted. The n data streams are thus substantially simultaneously each assigned to one of the n+1 data paths 280.

The training pattern is then communicated on the selected data path in step 550. The training pattern is repetitiously transmitted until receipt of a subsequent training done signal in step 510.

Referring to FIG. 2, the transmitter 210 and the receiver 250 select the same data path for calibration at substantially the same time. In one embodiment, the transmitter and receiver may select a pre-determined data path upon the initialization of the transmitter and receiver. The initialization may be part of a power-up sequence. In an alternative embodiment, the transmitter and receiver may be programmed to select a specific data path. In another alternative embodiment, the receiver may initially identify which data path is receiving the training pattern by analyzing each data path for the known training pattern.

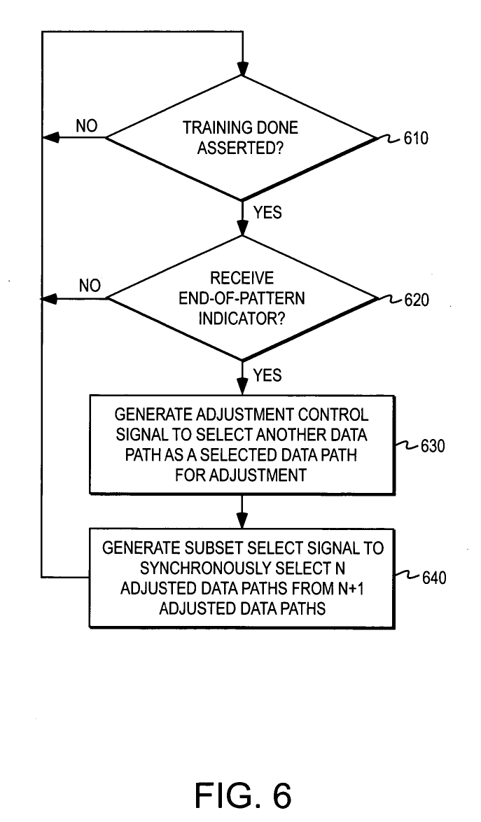

FIG. 6 illustrates one embodiment of the calibration process performed by the receiver 250, particularly the data analyzer 274 and data path adjuster 260. In step 610, the data analyzer determines whether the training done signal has been asserted. The data analyzer also determines whether the end-of-pattern indicator has been received in step 620.

If the end-of-pattern indicator appears while the training done signal is asserted then the receiver must transition to accommodate the re-assignment of data streams to data paths performed by the transmitter. Accordingly in step 630 the data analyzer generates an adjust control signal to select another data path as the selected data path for adjustment.

In step 640, a subset select signal is generated to synchronously select n adjusted data paths as output paths from the n+1 adjusted data paths. In one embodiment, the data analyzer generates the appropriate subset select signal 276 to synchronously select n adjusted data paths from the n+1 adjusted data paths 262 as output paths 266. The synchronous selection of the n adjusted data paths occurs at the first clock cycle subsequent receipt of the end-of-pattern indicator to avoid loss of data. In one embodiment, selection of the selected data path for adjustment also occurs as the first clock cycle subsequent receipt of the end-of-pattern indicator.

As the training pattern is switched from one data path to another by the transmitter, the receiver selects a different n subset of the n+1 adjusted data paths 262 provided by the data path adjuster as output paths 266. The subset of the n+1 adjusted data paths 262 is selected by the n-data path selector 264 in accordance with the subset select 276 provided by the data analyzer 274. The collection of n output paths 266 is a proper subset of the set of n+1 adjusted data paths 262 which themselves have a one-to-one correspondence with the set of n+1 data paths 280 from the transmitter 210.

The receiver's n-data path selector 264 and subset select 276 are complementary to the transmitter's multiplexers 220-240 and select 242. The n-data path select 264 may similarly comprise a plurality of multiplexers each of which is uniquely controlled by subset select 276. In one embodiment, subset select 276 is a plurality of individual signal lines wherein each multiplexer within the n-data path selector 264 is controlled by a unique subset of those signal lines.

Although the adjust control 286 determines which of the n+1 transmitted data paths 280 is selected for calibration, the adjust control 286 may be used during calibration to direct the data path adjuster 260. For example, in an application where the data paths 280 are utilized as distinct serial data paths, the bit rate of individual data paths may be different. The adjust control 286 may be used to convey the expected bit rate to the data path adjuster 260 to facilitate faster convergence of the calibration. The adjust control 286 may similarly be used to set maximum or minimum levels for phase, gain, or d.c. offset adjustments. In the event that data paths 280 are bi-directional, for example, adjust control 286 may be used to establish a handshaking protocol for calibration (e.g., start at highest baud rate and proceed to lower baud rates until calibration is effective, etc.). The handshaking protocol may involve interaction between the receiver 250 and the transmitter 210. The interaction may be performed by way of the data paths 280 or by way of additional signals not shown in FIG. 2.

In one embodiment, the data analyzer receives the reference clock 290 without adjustment. In an alternative embodiment, the data analyzer receives an adjusted reference clock 292.

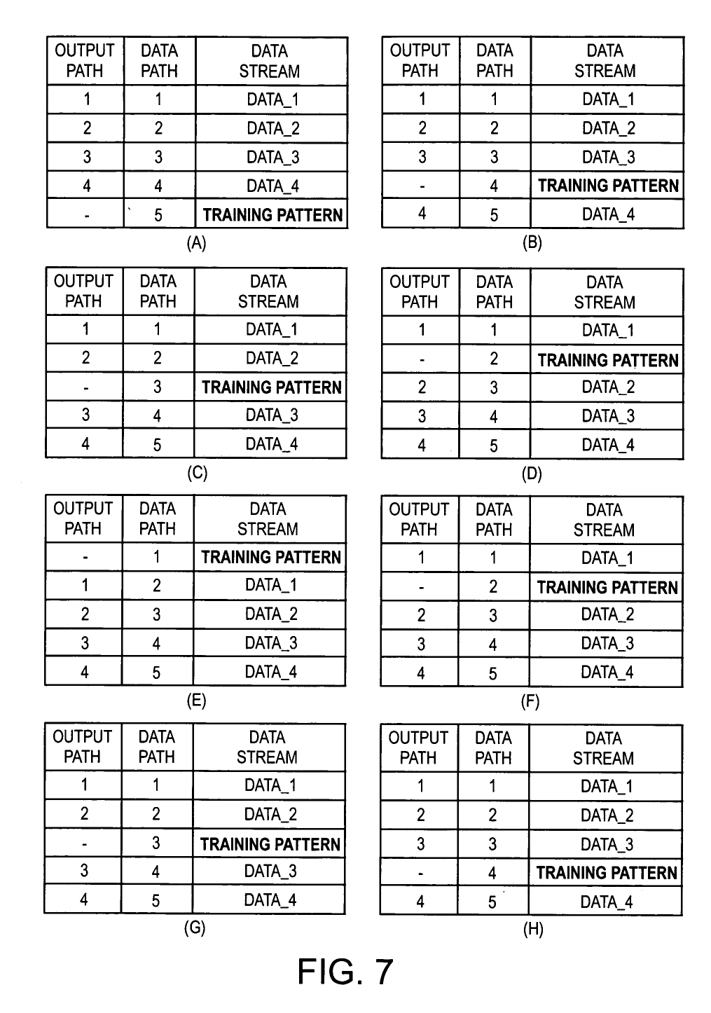

FIG. 7 illustrates one embodiment of sequentially selecting a data path for communicating the training pattern and the assignment of data streams to the remaining data paths. In the illustrated embodiment, the data paths are selected in the repeating sequence 5-4-3-2-1-2-3-4 for calibration. Thus in one embodiment, the length of the selection sequence is 2(n+1)−2=2n, where n+1 is the total number of data paths.

Tables (A)-(H) illustrate association of data streams to different data paths (e.g., 280) and in turn output paths (e.g., 266) when progressing through the sequence. In the illustrated embodiment, n=4 and n+1=5 thus supporting continuous communication for up to 4 individual serial paths or one 4 bit wide parallel path while calibrating. Following the selection sequence from Tables (A) to (H), the sequence would repeat beginning again with the data stream-to-data path assignment set forth in Table (A).

The sequence and data stream assignments of FIG. 7 ensure that the multiplexers associated with the first and last data paths need only select between one data stream and the training pattern. All other multiplexers must have the capability of selecting between the training pattern and two other data streams, i.e., for any multiplexer m indexed such that 1<m<n+1 multiplexer m must be capable of selecting from the set {training pattern, DATA_m, DATA_m⁻¹}.

As can be seen from Tables (A), (B), (C), (G), and (H), when m=2, the multiplexer must be capable of selecting DATA_2. Obviously the same multiplexer must be capable of selecting the training pattern (see, Tables (D), (F)) for calibration. Finally, Table (E) illustrates that multiplexer m=2 must similarly be capable of selecting DATA_1.

The embodiment illustrated in FIG. 2 supports the sequence illustrated in FIG. 7. Thus multiplexer 220 associated with the first data path need only select between DATA_1 and the training pattern. Multiplexer 240 associated with the last (n+1) data path need only select between DATA_n and the training pattern. The other multiplexers controlled by the training pattern state machine 244 must be capable of selecting between two data streams and the training pattern 232. Thus for example, multiplexer 230 (m=2) selects from the set {DATA_2. DATA_1, training pattern}.

Sequences and data stream assignments other than those set forth in FIG. 7 may be used. Thus for example, the data paths may be selected in the repeating sequence 5, 3, 1, 4, 2 for calibration. Obviously if there are n+1 data paths, then there are (n+1)! distinct possible sequences (when the sequence length is n+1), where “!” is the factorial function. Of course the sequence may be longer as disclosed above, thus introducing even a greater number of possible sequences.

For the n data paths not being calibrated, there are n! possible associations between the n data paths and the n data streams. Although the remaining n multiplexers may be configured to select any of the n data streams as long as each of the n data streams is uniquely selected by one of the n multiplexers, using random assignments between the multiplexers and data streams tends to impose greater capabilities on both the multiplexers and the training pattern state machine.

Generally, fewer changes in assignments between data paths and data streams implies greater simplicity of design for the multiplexers 220-240, the training pattern state machine 244, and the receiver 250. The sequence and assignment illustrated in FIG. 7, for example, ensures that the data streams retain their relative orderings and does not require re-ordering of the subset of selected data paths to accurately reflect parallel data communications.

The data paths are thus “minimally disturbed” during the calibration process since the relationship between any given input data stream and output data path is maintained until that given input data stream must be re-assigned due to calibration of its assigned data path. The preservation of relative order ensures that re-assignment of one data stream at the transmitter does not trigger cascading re-assignments at the receiver in order to preserve order of the output data paths.

Methods and apparatus for calibrating or testing data paths coupling a receiver and a transmitter have been described. Various modifications and changes may be made thereto without departing from the broader scope of the invention as set forth in the claims. The specification and drawings are, accordingly, to be regarded in an illustrative rather than a restrictive sense.

What is claimed is:

1. A communication apparatus, comprising:
a transmitter providing a training pattern on a selected one of n+1 data paths while communicating data on the remaining n of the n+1 data paths;
a receiver having adjuster circuitry receiving the n+1 data paths and providing n+1 adjusted data paths, wherein the receiver selects a subset of the n+1 adjusted data paths carrying the communicated data while adjusting the selected data path.

2. The apparatus of claim 1 wherein the data paths are individual serial data paths.

3. The apparatus of claim 1 wherein n of the n+1 data paths collectively form a parallel communication path for communicating n-bit data.

4. The apparatus of claim 1 wherein the transmitter selects the selected data path from the plurality of data paths in a pre-determined sequence.

5. The apparatus of claim 4 wherein the sequence has a length of 2n.

6. The apparatus of claim 4 wherein the sequence has a length of n+1.

7. The apparatus of claim 1 wherein the transmitter assigns each of a plurality of data streams to one of the non-selected data paths.

8. The apparatus of claim 7 wherein the transmitter selects the selected data path from the plurality of data paths in a pre-determined sequence, wherein the assignment of the plurality of data streams to non-selected data paths preserves the relative order of the data streams.

9. The apparatus of claim 1 wherein at least one of the data paths is an optical communication path.

10. The apparatus of claim 1 wherein at least one of the data paths is an electrical communication path.

11. The apparatus of claim 1 wherein at least one of the data paths is a time division multiplexed data path.

12. The apparatus of claim 1 wherein the adjuster circuitry performs at least one of a d.c. offset, a phase, and a gain adjustment.

13. The apparatus of claim 1 wherein the transmitter generates an end-of-pattern indicator upon completion of adjusting the selected data path.

14. The apparatus of claim 13 wherein subsequent the transmission of the end-of-pattern indicator, the transmitter and receiver substantially simultaneously select another data path as the selected data path for communicating the training pattern.

15. A method comprising:
(a) sequentially selecting a selected data path from a plurality of data paths coupling a transmitter and a receiver;
(b) communicating a training pattern on the selected data path to the receiver; and
(c) adjusting the selected data path in response to the received training pattern.

16. The method of claim 15 wherein data is communicated on the non-selected data paths while the training pattern is communicated on the selected path.

17. The method of claim 16 wherein the non-selected data paths form an n-data path wide parallel communication path.

18. The method of claim 16 wherein the non-selected data paths are individual serial communication paths.

19. The method of claim 15 wherein there are n+1 data paths, wherein the sequential selection of the selected data path is a sequence of length 2n.

20. The method of claim 15 wherein there are n+1 data paths, wherein the sequential selection of the selected data path is a sequence of length n+1.

21. The method of claim 15 wherein the adjustment is at least one of a d.c. offset, gain, and phase adjustment.

22. The method of claim 15 wherein at least one of the data paths is a time division multiplexed data path.

23. The method of claim 15 wherein the transmitter selects the selected data path from the plurality of data paths in a pre-determined sequence, wherein the assignment of the plurality of data streams to non-selected data paths preserves the relative order of the data streams.

24. The method of claim 15 wherein the transmitter generates an end-of-pattern indicator upon completion of adjusting the selected data path.

25. The method of claim 24 wherein subsequent transmission of the end-of-pattern indicator, the transmitter and receiver substantially simultaneously select another data path as the selected data path for communicating the training pattern.
